(19) United States
(12) Patent Application Publication
(10) Pub. No.: US 2025/0335283 A1
(43) Pub. Date: Oct. 30, 2025

(54) WORKLOAD CONTEXT AWARE DYNAMIC MEMORY TUNING

(71) Applicant: Dell Products L.P., Round Rock, TX (US)

(72) Inventors: Pravin JANAKIRAM, Bangalore (IN); Prasant Kumar HOTA, Bangalore (IN); Vinod Parackal SABY, Bangalore (IN); David Keith CHALFANT, Round Rock, TX (US); Jordan CHIN, Austin, TX (US)

(73) Assignee: Dell Products L.P., Round Rock, TX (US)

(21) Appl. No.: 18/650,835

(22) Filed: Apr. 30, 2024

(51) Int. Cl. G06F 11/07

(52) U.S. Cl. CPC G06F 11/0772; G06F 11/079

(57) ABSTRACT

An information handling system may include at least one processor and a memory element. The information handling system may be configured to: determine a category for at least one software application running on the at least one processor, wherein the category is indicative of a degree to which the at least one software application utilizes the memory element; and based on the determined category, adjust a parameter associated with the memory element, wherein the parameter relates to predictive failure analysis of the memory element.

### TECHNICAL FIELD

The present disclosure relates to in general information handling systems, and more particularly to the management of memory errors in information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems generally include memory elements that are used for data storage. For example, Double Data Rate 5 Synchronous Dynamic Random-Access Memory (DDR5 SDRAM) is often deployed in current systems. Such memory may or may not include error correction code (ECC) features, but in either case, it is subject to errors from time to time. For example, the value of a bit in memory may flip due to cosmic rays, voltage fluctuations, manufacturing problems, physical damage, etc.

Currently, a static prediction failure analysis (PFA) is employed (e.g., implemented in the BIOS) to determine if the error rate associated with a memory element is within its expected limits, or if it has exceeded a threshold indicating that (reliability, a RAS availability, serviceability) action should be taken (e.g., disabling the element, dispatching a replacement, or other corrective actions). For example, this method may be used to monitor the number and/or frequency of corrected memory errors in order to prevent subsequent uncorrected errors from occurring.

This type of mechanism is used to predict the potential impact of excessive rates of memory data errors using static threshold values for the error rate, which are compared to the actual measured error rates on the memory elements in server systems. Corrective memory RAS actions are dispatched when specific error thresholds are crossed. However, current solutions do not account for varying workloads with different rates of processor and memory utilization. This is a problem because higher utilization rates are associated with higher error rates, even in memory elements that are operating normally.

This disclosure thus provides improved techniques that account for the increased memory data error rates that are expected to result from the increased processor and memory utilization associated with intensive workloads.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with predictive failure analysis of memory elements may be reduced or eliminated.

In accordance with embodiments of the present disclosure, an information handling system may include at least one processor and a memory element. The information handling system may be configured to: determine a category for at least one software application running on the at least one processor, wherein the category is indicative of a degree to which the at least one software application utilizes the memory element; and based on the determined category, adjust a parameter associated with the memory element, wherein the parameter relates to predictive failure analysis of the memory element.

In accordance with these and other embodiments of the present disclosure, a method may include an information handling system determining a category for at least one software application running on at least one processor thereof, wherein the category is indicative of a degree to which the at least one software application utilizes a memory element of the information handling system; and based on the determined category, the information handling system adjusting a parameter associated with the memory element, wherein the parameter relates to predictive failure analysis of the memory element.

In accordance with these and other embodiments of the present disclosure, an article of manufacture may include a non-transitory, computer-readable medium having computer-executable instructions thereon that are executable by a processor of an information handling system for: determining a category for at least one software application running on the processor, wherein the category is indicative of a degree to which the at least one software application utilizes a memory element of the information handling system; and based on the determined category, adjusting a parameter associated with the memory element, wherein the parameter relates to predictive failure analysis of the memory element.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates an example architecture, in accordance with embodiments of the present disclosure; and

FIG. 3 illustrates an example method, in accordance with embodiments of the present disclosure.

### DETAILED DESCRIPTION

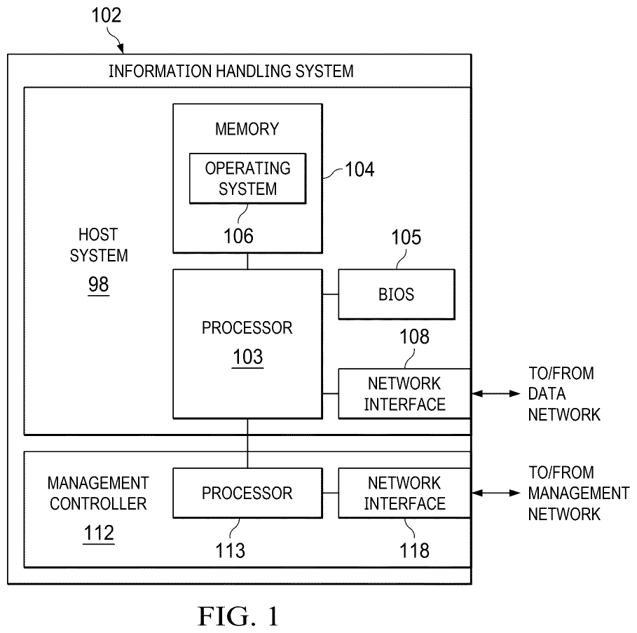

Preferred embodiments and their advantages are best understood by reference to FIGS. 1 through 3, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-may transitory computer-readable medium) include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure provide improved techniques for analysis of memory errors that take into account the current workload of an information handling system.

Embodiments provide a mechanism to detect the current workload based on the OS and applications that are running on a server. The PFA threshold settings and behavior may be dynamically modified to account for the current workload.

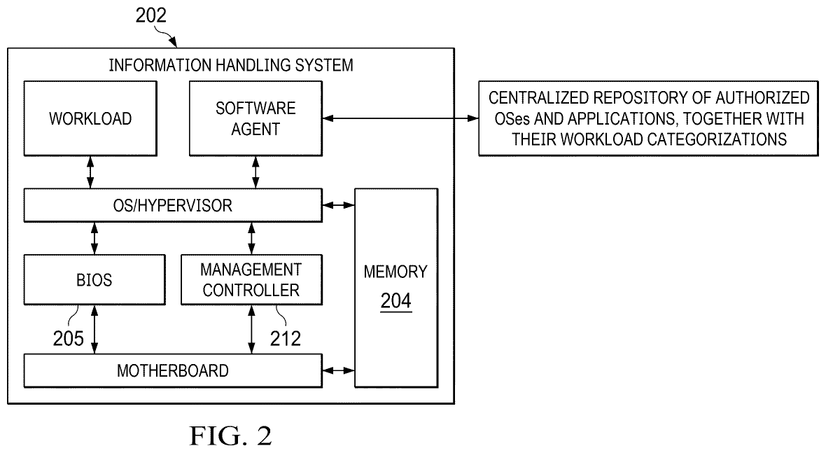

Turning now to FIG. 2, an example architecture diagram is shown. Information handling system 202 executes both its normal workload as well as a software agent referred to herein as a workload aware memory performance tuning agent (WAMPTA), which may run under the OS and/or the Hypervisor. The software agent detects the current workload and transmits workload details to the BIOS through the use of software-generated System Management Interrupts (SMI). (Other embodiments discussed below may utilize a management controller 212 such as a BMC instead of or in addition to the BIOS.)

The BIOS may then service these SMIs to detect the current workload and make any adjustment to the PFA thresholds and behavior as appropriate.

The WAMPTA software agent may detect and categorize the workload based on a centrally available whitelist of various OSes and applications that are authorized to be installed in information handling systems in the datacenter, and their respective workload categories. For example, a workload such as a mail server may be categorized as relatively low-intensity, while a workload such as artificial intelligence model training may be categorized as relatively high-intensity. In some embodiments, the software agent may analyze the actual processor and memory utilization in addition to the workload categories.

In general, the centralized repository may contain a whitelist of organization-approved and/or popular software applications with workload categorization based on the objectives of each application, how each application consumes and uses memory, and the impact of critical memory errors on each application. This list may be maintained both by administrators and dynamically updated/amended based on the user selection/categorization during the installation of various applications on the information handling systems.

The list of workloads and their categories may be pulled to information handling system 202 periodically to have the latest information for reference. Additional parameters that may be monitored and considered to make optimized configurations based on the workload may include:

1. Error Threshold: Details of various error thresholds effective in the system run time.

2. Count of memory devices: Details of the count and type of memory devices, their connectivity details, etc.

3. Memory physical balancing status: Details of available physical memory, distribution of data with respect to physical device presence.

4. Status of memory (usage) balance: Details of used and unused memory, along with their physical locations.

5. Internal Ambient Temperature: Internal ambient temperature at which the memory devices are operating. Higher temperatures are associated with higher error rates.

6. Memory Errors Trend: History of errors that have occurred on the memory devices and details of their current workload assignment.

Based on the workload and the parameters listed above, the WAMPTA software agent may notify the BIOS to change the memory data error threshold(s) and/or PFA behavior based on runtime changes to the workload profile and/or system utilization.

The software agent that provides workload and other details may also optimize RAS actions and behaviors based on the way the system is responding to memory RAS corrective actions. For example, the RAS algorithm might preferentially request OS memory page retirement when possible to avoid using limited PPR (Post Package Repair) or ADDDC (Adaptive Double DRAM Device Correction) hardware resources. Further, the RAS algorithm might not issue any OS memory page retirement request(s) if this feature is not supported or is disabled, instead dispatching a PPR request. Further, the RAS algorithm may proceed with using PPR or ADDDC when OS page retirement is supported and has already been requested, but the system is still generating an excessive corrected memory data error rate.

Thus according to one embodiment, the WAMPTA software agent running on the host OS/Hypervisor monitors active processes (e.g., applications), processor utilization, and memory utilization to detect the workload. WAMPTA may perform the workload category identification with the help of a whitelist of authorized applications maintained in a centralized server, or it may categorize based on actual utilization numbers, or it may perform a combination of the above.

WAMPTA then uses SMIs to communicate dynamic changes in workload details to BIOS. Meanwhile, a management controller such as the system BMC may monitor changes to the various parameters through out-of-band and/or side-band interfaces and pass the information to the BIOS by generating a SMI (e.g., via a baseboard GPIO pin assertion).

The BIOS, upon receiving a SMI from WAMPTA and/or the BMC, retrieves information regarding the modified workload deployed on the system and updates the PFA thresholds and behavior accordingly. WAMPTA feeds workload information and configuration details to the OS/Hypervisor RAS logic to optimize RAS actions based on the current processor and memory utilization.

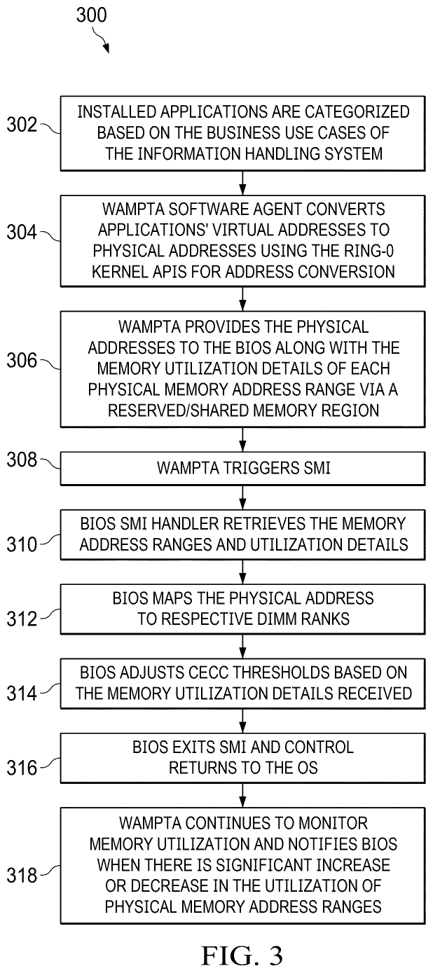

FIG. 3 illustrates a flow chart of an example method 300 for performing workload aware dynamic memory tuning. At step 302, the applications installed on an information handling system are categorized based on whether they represent demanding or non-demanding workloads. At step 304, the WAMPTA software agent begins the process of associating each application with the physical memory elements that it uses by converting virtual address ranges to physical address ranges.

At step 306, the WAMPTA provides the physical address information to the BIOS. This may be accomplished via the use of a shared memory region. At step 308, the WAMPTA triggers an SMI.

At step 310, the BIOS SMI handler retrieves the physical memory address ranges and utilization details from shared memory, and at step 312 the BIOS determines the physical address ranges to the actual memory elements associated therewith.

At step 314, the BIOS adjusts the corrected ECC error (CECCC) thresholds and any other suitable parameters based on the memory utilization and workload details provided by the WAMPTA. These parameters may be adjusted on any desired granularity (e.g., per-rank, per chip, per DIMM, etc.). For example, the RAS CECCC threshold count per rank and/or the threshold leaky bucket timeout period for the rank may be adjusted for higher workloads by increasing the threshold count and/or reducing the leaky bucket timeout period. (When utilization is low, parameters may be adjusted in the opposite direction.)

The BIOS then exits the SMI at step 316, and the WAMPTA continues monitoring the system at step 318.

One of ordinary skill in the art with the benefit of this disclosure will understand that the preferred initialization point for the method depicted in FIG. 3 and the order of the steps comprising the method may depend on the implementation chosen. In these and other embodiments, these method may be implemented as hardware, firmware, software, applications, functions, libraries, or other instructions. Further, although FIG. 3 discloses a particular number of steps to be taken with respect to the disclosed method, the method may be executed with greater or fewer steps than depicted. The method may be implemented using any of the various components disclosed herein (such as the components of FIG. 1), and/or any other system operable to implement the methods.

The foregoing has focused mainly on an embodiment in which the BIOS handles the adjustment of the memory parameters. According to another embodiment, a management controller such as a BMC may offload the memory RAS functionality from the BIOS. Responsibility for PFA thresholds thus transitions from BIOS ownership to BMC ownership.

In such a situation, the host processors may support a RAS API that allows the BMC to directly read correctable error information. This has the benefit of avoiding the use of costly SMIs.

In particular, the WAMPTA may be implemented to support direct communication with the BMC (e.g., using an interface such as keyboard controller style (KCS), memory-mapped BMC interface (MMBI), USB-NIC, etc. WAMPTA may use this interface to communicate dynamic changes in workload details to the BMC instead of the BIOS.

The BMC may, upon receiving new workload data from the WAMPTA and in conjunction with the various system utilization parameters it already has access to through out-of-band and/or side-band interfaces, updates its PFA thresholds and behavior accordingly.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory element;
wherein the information handling system is configured to:
determine a category for at least one software application running on the at least one processor, wherein the category is indicative of a degree to which the at least one software application utilizes the memory element; and
based on the determined category, adjust a parameter associated with the memory element, wherein the parameter relates to predictive failure analysis of the memory element.

2. The information handling system of claim 1, further configured to communicate the category to a basic input/output system (BIOS) of the information handling system via a system management interrupt (SMI), wherein the BIOS is configured to adjust the parameter.

3. The information handling system of claim 1, further configured to communicate the category to a management controller of the information handling system, wherein the management controller is configured to adjust the parameter.

4. The information handling system of claim 1, wherein the parameter is further adjusted based on a determination of actual utilization of the memory element.

5. The information handling system of claim 1, further configured to determine a mapping between a plurality of software applications and a plurality of memory elements.

6. The information handling system of claim 1, wherein the memory element is a rank of a dual inline memory module (DIMM).

7. A method comprising:
an information handling system determining a category for at least one software application running on at least one processor thereof, wherein the category is indicative of a degree to which the at least one software application utilizes a memory element of the information handling system; and
based on the determined category, the information handling system adjusting a parameter associated with the memory element, wherein the parameter relates to predictive failure analysis of the memory element.

8. The method of claim 7, further comprising communicating the category to a basic input/output system (BIOS) of the information handling system via a system management interrupt (SMI), wherein the BIOS adjusts the parameter.

9. The method of claim 7, further comprising communicating the category to a management controller of the information handling system, wherein the management controller adjusts the parameter.

10. The method of claim 7, wherein the parameter is further adjusted based on a determination of actual utilization of the memory element.

11. The method of claim 7, further comprising determining a mapping between a plurality of software applications and a plurality of memory elements.

12. The method of claim 7, wherein the memory element is a rank of a dual inline memory module (DIMM).

13. An article of manufacture comprising a non-transitory, computer-readable medium having computer-executable instructions thereon that are executable by a processor of an information handling system for:
determining a category for at least one software application running on the processor, wherein the category is indicative of a degree to which the at least one software application utilizes a memory element of the information handling system; and
based on the determined category, adjusting a parameter associated with the memory element, wherein the parameter relates to predictive failure analysis of the memory element.

14. The article of claim 13, wherein the instructions are further executable for communicating the category to a basic input/output system (BIOS) of the information handling system via a system management interrupt (SMI), and wherein the BIOS is configured to adjust the parameter.

15. The article of claim 13, wherein the instructions are further executable for communicating the category to a management controller of the information handling system, wherein the management controller is configured to adjust the parameter.

16. The article of claim 13, wherein the parameter is further adjusted based on a determination of actual utilization of the memory element.

17. The article of claim 13, wherein the instructions are further executable for determining a mapping between a plurality of software applications and a plurality of memory elements.

18. The article of claim 13, wherein the memory element is a rank of a dual inline memory module (DIMM).
